(19) United States
(12) Patent Application Publication
(10) Pub. No.: US 2026/0133035 A1
(43) Pub. Date: May 14, 2026

(54) NAVIGATION SUPPORT SYSTEM, NAVIGATION SUPPORT METHOD, AND COMPUTER-READABLE RECORDING MEDIUM

(71) Applicant: FURUNO ELECTRIC CO., LTD., Hyogo (JP)

(72) Inventor: Hiroki MURAKAMI, Kobe-City (JP)

(73) Assignee: FURUNO ELECTRIC CO., LTD., Hyogo (JP)

(21) Appl. No.: 19/382,152

(22) Filed: Nov. 6, 2025

(30) Foreign Application Priority Data
Nov. 8, 2024 (JP) 2024-195952

(51) Int. Cl. G01C 21/20; G01S 13/06; G06V 10/25; G06V 20/56; H04N 23/695

(52) U.S. Cl. CPC G01C 21/203; G01S 13/06; G06V 10/25; G06V 20/56; H04N 23/695

(57) ABSTRACT

Provided is a navigation support system. The navigation support system includes: a camera installed on a ship and configured to acquire an image including an object at sea; an orientation sensor configured to detect a bow direction of the ship; an object sensor configured to detect a position of the object; processing circuitry configured to recognize a region of the object in the image, and calculate a difference between a capturing direction of the camera and the bow direction based on a horizontal in-image position of the object in the image and a direction of the object with reference to the ship.

### CROSS-REFERENCE TO RELATED APPLICATION

This application claims the priority benefits of Japanese application no. 2024-195952, filed on Nov. 8, 2024. The entirety of the above-mentioned patent application is hereby incorporated by reference herein and made a part of this specification.

### BACKGROUND

### Technical Field

The disclosure relates to a navigation support system, a navigation support method, and a computer-readable recording medium.

### Related Art

Conventionally, a technology for detecting objects on the sea, such as ships, in images captured by a camera mounted on a ship using image recognition is known.

Incidentally, cameras mounted on ships are typically installed facing, for example, the bow direction. However, there may be cases where the capturing direction of the camera shifts from the intended direction. In such cases, there is a risk that the direction of objects detected by image recognition cannot be correctly grasped.

The disclosure has been made in view of the issue, and its main purpose is to provide a navigation support system, a navigation support method, and a computer-readable recording medium capable of specifying the capturing direction of a camera.

### SUMMARY

According to one aspect of the disclosure, a navigation support system includes a camera installed on a ship and configured to acquire an image including an object at sea; an image recognition unit configured to recognize a region of the object in the image; an orientation sensor configured to detect a bow direction of the ship; an object sensor configured to detect a position of the objects; and a calculation unit configured to calculate a difference between a capturing direction of the camera and the bow direction based on a horizontal in-image position of the object in the image and a direction of the object with reference to the ship. This makes it possible to specify the capturing direction of the camera.

In the aspect, the camera may include a drive unit configured to change the capturing direction horizontally. This makes it possible to specify the capturing direction of the camera even for a camera capable of changing its capturing direction horizontally.

In the aspect, the calculation unit may calculate the capturing direction of the camera with reference to the bow direction. This makes it possible to specify the capturing direction of the camera with reference to the bow direction.

In the aspect, the system may further include an identification unit configured to identify the object recognized in the image with the object detected by the object sensor. This makes it possible to identify the object recognized in the image with the object detected by the object sensor.

In the aspect, the identification unit may identify a plurality of the objects based on a horizontal appearance pattern of a plurality of the objects in the image and a circumferential appearance pattern of a plurality of the objects with reference to the ship. This makes it possible to identify a plurality of objects.

In the aspect, the image recognition unit may further recognize a size of the object, the object sensor may further detect the size of the objects, and the identification unit may further identify the object based on the size of the objects. This makes it possible to improve the identification accuracy of the object.

In the aspect, the image recognition unit may further recognize an orientation of the objects, the object sensor may further detect the orientation of the objects, and the identification unit may further identify the object based on the orientation of the object. This makes it possible to improve the identification accuracy of the object.

In the aspect, the image recognition unit may further recognize a type of the object, the object sensor may further detect the type of the object, and the identification unit may further identify the object based on the type of the object. This makes it possible to improve the identification accuracy of the object.

In the aspect, the object sensor may be a radar. This makes it possible to specify the capturing direction of the camera by utilizing the position of the object detected by the radar.

In the aspect, the object sensor may be an AIS (Automatic Identification System). This makes it possible to specify the capturing direction of the camera by utilizing the position of the object detected by the AIS.

Moreover, according to another aspect of the disclosure, a navigation support method includes the following: an image including an object on the sea is acquired by a camera installed on a ship; a region of the object in the image is recognized; a bow direction of the ship is detected by an orientation sensor; a position of the object is detected by an object sensor; and a difference between a capturing direction of the camera and the bow direction is calculated based on a horizontal in-image position of the object in the image and a direction of the object with reference to the ship. This makes it possible to specify the capturing direction of the camera.

Moreover, according to another aspect of the disclosure, a computer-readable recording medium configured to record a program to cause a computer to: acquire an image including an object on the sea generated by a camera installed on a ship; recognize a region of the object in the image; acquire a bow direction of the ship detected by an orientation sensor; acquire a position of the object detected by an object sensor; and calculate a difference between a capturing direction of the camera and the bow direction based on a horizontal in-image position of the object in the image and a direction of the object with reference to the ship. This makes it possible to specify the capturing direction of the camera.

According to the disclosure, it is possible to specify the capturing direction of the camera.

### BRIEF DESCRIPTION OF THE DRAWINGS

FIG. 1 is a diagram illustrating an example of the system.

FIG. 2 is a diagram illustrating an example of the processing circuitry.

FIG. 3 is a diagram illustrating an example of the camera.

FIG. 4 is a diagram illustrating an example of the relationship between the bow direction and the capturing direction.

FIG. 5 is a diagram illustrating an example of an object database for the camera.

FIG. 6 is a diagram illustrating an example of an object database for the sensor.

FIG. 7 is a diagram for describing the identification of objects and calibration of the capturing direction.

FIG. 8 is a diagram for describing the identification of objects and calibration of the capturing direction.

FIG. 9 is a diagram for describing the identification of objects and calibration of the capturing direction.

FIG. 10 is a diagram illustrating an example of the navigation support method.

### DESCRIPTION OF THE EMBODIMENTS

The following describes embodiments of the disclosure with reference to the drawings. In this specification and the drawings, elements similar to those described previously in relation to earlier figures may be given the same reference numerals, and detailed explanations may be omitted as appropriate.

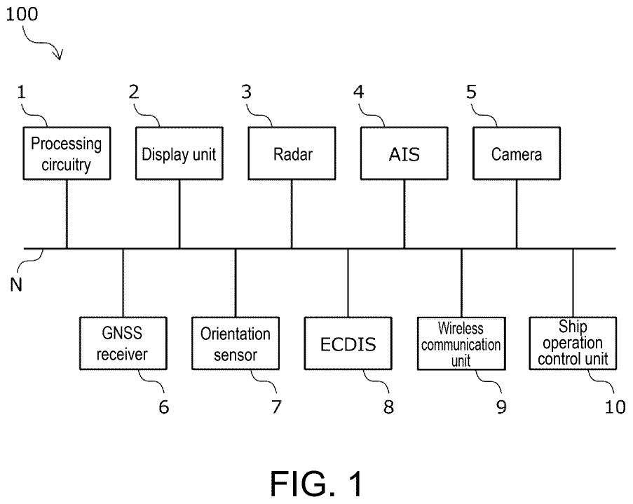

FIG. 1 is a block diagram illustrating a configuration example of a navigation support system 100. The navigation support system 100 is a system installed on a ship. In the following description, the ship on which the navigation support system 100 is installed may also be referred to as “own ship”, and other ships may be referred to as “other ships”.

The navigation support system 100 includes processing circuitry 1, a display unit 2, a radar 3, an AIS 4, a camera 5, a GNSS receiver 6, an orientation sensor 7, an ECDIS 8, a wireless communication unit 9, and a ship operation control unit 10. These devices are connected to a network N such as a LAN, and are capable of network communication with each other.

The processing circuitry 1 includes a computer including a CPU, RAM, ROM, non-volatile memory, and input/output interfaces, etc. The CPU of the processing circuitry 1 executes information processing according to a program loaded into RAM from ROM or non-volatile memory.

The program may be supplied via an information storage medium such as an optical disc or memory cards, etc., or may be supplied via a communication network such as the Internet or LAN, etc.

The display unit 2 displays images for display generated by the processing circuitry 1. The display unit 2 also displays radar images, camera images, or electronic nautical charts, etc.

The display unit 2 is, for example, a display device with a touch sensor, known as a touch panel, which detects the indicated position on the screen by a user's finger, etc. Alternatively, the indicated position may be input by a pointing device such as a trackball, etc.

The radar 3 emits radio waves around the own ship and receives reflected waves, generating echo data based on the received signal. In addition, the radar 3 identifies objects from the echo data and generates TT data (Target Tracking Data) representing the position and velocity of the objects.

The AIS (Automatic Identification System) 4 receives AIS data from other ships existing around the own ship or from shore-based control. Instead of AIS, VDES (VHF Data Exchange System) may be used. The AIS data includes identification codes, ship names, positions, headings, ship speeds, ship types, ship lengths, and destinations, etc. of other ships.

The camera 5 is a digital camera that captures images of the exterior from the own ship and generates image data. The camera 5 is, for example, installed on the bridge of the own ship facing the bow orientation. The camera 5 is, for example, a so-called PTZ camera having pan and tilt function and optical zoom function.

The camera 5 may include an image recognition unit that estimates the in-image position and type of objects on the sea, such as other ships, included in a captured image using an object detection model. The image recognition unit may be implemented in other devices such as the processing circuitry 1, not limited to the camera 5.

The GNSS receiver 6 detects the position of the own ship based on radio waves received from GNSS (Global Navigation Satellite System). The orientation sensor 7 is, for example, a GPS compass or a gyrocompass, and detects the bow direction of the own ship.

The ECDIS (Electronic Chart Display and Information System) 8 acquires the position of the own ship from the GNSS receiver 6 and displays the position of the own ship on an electronic nautical chart. In addition, the ECDIS 8 displays the planned route of the own ship on the electronic nautical chart. Instead of ECDIS, a GNSS plotter may be used.

The wireless communication unit 9 includes wireless equipment that enables satellite communication. In addition, the wireless communication unit 9 includes wireless equipment that enables ship-to-shore or ship-to-ship wireless communication using, for example, ultra-high frequency waves, very high frequency waves, high frequency waves, or medium waves, etc.

The ship operation control unit 10 is a control device for realizing autonomous navigation and controls the steering gear of the own ship. In addition, the ship operation control unit 10 may control the engine of the own ship.

In this embodiment, the processing circuitry 1 and the display unit 2 are independent devices from each other, but the disclosure is not limited to such configuration. The processing circuitry 1 and the display unit 2 may be integrated into a single device.

In addition, the processing circuitry 1 is not limited to being an independent device, but may be integrated with other devices such as the ECDIS 8. In other words, some or all of the functions of the processing circuitry 1 may be implemented in other devices.

Moreover, the display unit 2 is not limited to being an independent device. The display unit of other devices such as the ECDIS 8 may be used as the display unit 2 to display the images for display generated by the processing circuitry 1.

In addition, the processing circuitry 1 and the display unit 2 may be installed in a shore-based control and used to monitor ships navigating in a managed sea area.

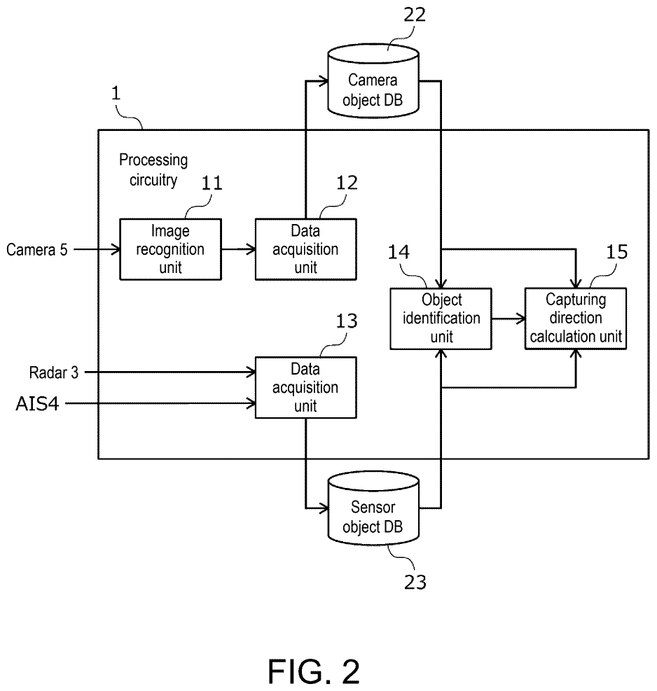

FIG. 2 is a block diagram illustrating a configuration example of the processing circuitry 1. The processing circuitry 1 includes an image recognition unit 11, a data acquisition unit 12, a data acquisition unit 13, an object identification unit 14, and a capturing direction calculation unit 15. The functional units are realized by the CPU of the processing circuitry 1 executing information processing according to a program.

In addition, the processing circuitry 1 may access a camera object DB (database) 22 and a sensor object DB (database) 23. The database 22 and the database 23 may be constructed in the memory of the processing circuitry 1 or may be constructed in an external storage device.

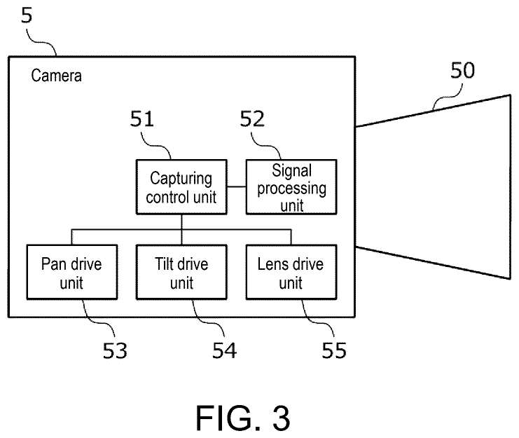

FIG. 3 is a block diagram illustrating a configuration example of the camera 5. The camera 5 is a PTZ camera with pan and tilt function and optical zoom function, and includes a capturing control unit 51, a signal processing unit 52, a pan drive unit 53, a tilt drive unit 54, and a lens drive unit 55.

The pan drive unit 53 changes the capturing direction of the camera 5 horizontally, and the tilt drive unit 54 changes the capturing direction of the camera 5 in the vertical direction. The pan drive unit 53 and the tilt drive unit 54 are examples of a posture control unit. The lens drive unit 55 changes the focal length of a zoom lens 50 to zoom in or zoom out on a subject.

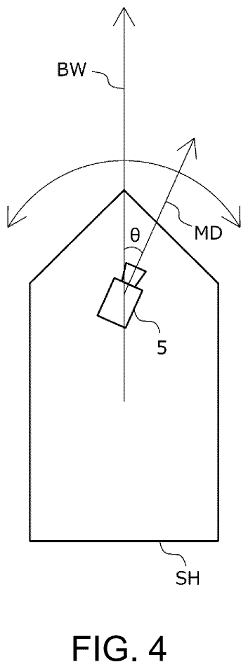

FIG. 4 is a diagram illustrating an example of the relationship between a bow direction BW of an own ship SH and a capturing direction MD of the camera 5. The camera 5 captures images of the surroundings of the own ship SH while changing the capturing direction MD horizontally, that is, while panning.

Incidentally, the camera 5 is installed such that the reference position of the capturing direction MD (for example, the center of the movable range) faces the bow direction BW, etc. However, in reality, there may be errors in the capturing direction MD. If there are errors in the capturing direction MD, there is a risk that the positions of objects existing around the own ship SH cannot be correctly grasped.

Therefore, in this embodiment, as described below, calibration of the capturing direction MD of the camera 5 is made possible by utilizing data detected by an object sensor such as the radar 3 or AIS 4.

Returning to the description of FIG. 2, the image recognition unit 11 acquires an image generated by the camera 5 installed on the own ship SH, and recognizes the region of the object in the image by inputting the acquired image into a region recognition model. The region recognition model is a trained model based on machine learning. Not limited to this, the region recognition model may be a rule-based calculation model.

The region recognition model is, for example, an object detection model such as YOLO (You Only Look Once) or SSD (Single Shot MultiBox Detector), and outputs a bounding box surrounding an object included in the image. Not limited to this, the region recognition model may be a region segmentation model such as Semantic Segmentation or Instance Segmentation.

The data acquisition unit 12 acquires object data of the object included in the image based on the recognition result of the image by the image recognition unit 11, and registers it in the camera object DB 22. The object data includes the direction of the object with reference to the own ship SH.

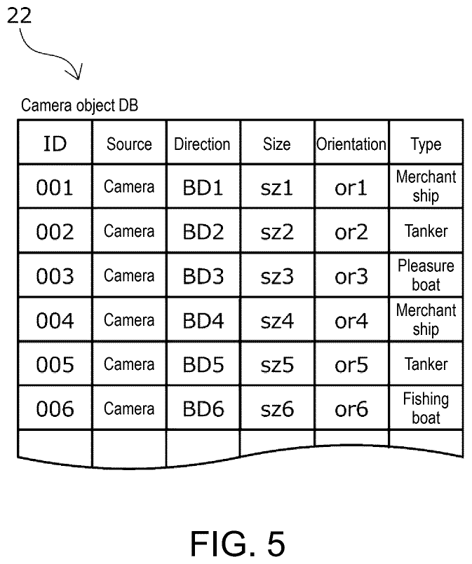

The camera object DB 22 includes fields such as “ID”, “Source”, “Direction”, “Size”, “Orientation”, and “Type” as illustrated in FIG. 5.

“ID” is an identifier of the object recognized from the image. “Source” indicates that the object data was acquired by the camera 5.

“Direction” represents the direction of the object with reference to the own ship SH. The direction of the object is calculated based on the capturing direction MD of the camera 5, the horizontal angle of view of the camera 5, and the horizontal in-image position of the object in the image.

The capturing direction MD of the camera 5 is calculated, for example, by acquiring the rotation angle of the pan drive unit 53 of the camera 5. In the case where the camera 5 does not have a pan function, the capturing direction MD of the camera 5 is a fixed value.

“Size” represents the size of the object. The size of the object is calculated based on the size of the region of the object in the image. The region of the object is a bounding box surrounding the object.

“Orientation” represents the orientation of the object. The orientation of the object may be, for example, the course of the object calculated based on the temporal change of the in-image position of the object, or it may be the heading (bow orientation) of the object identified from the image of the object.

“Type” represents the type of the object. The type of the object is, for example, identified from the image of the object using a trained model. The type of the object is, for example, the type of ship such as pleasure boat, fishing boat, merchant ship, or tanker.

The camera object DB 22 may further include the position and velocity of the object, etc. The position of the object is calculated, for example, based on the direction of the object and the distance from the own ship to the object estimated by the trained model, and the velocity of the object is calculated based on the temporal change of the position of the object.

The data acquisition unit 13 acquires the object data of the object detected by an object sensor such as the radar 3 or AIS 4, and registers it in the sensor object DB 23. The object data is, for example, TT data or AIS data, and includes the position of the object, etc.

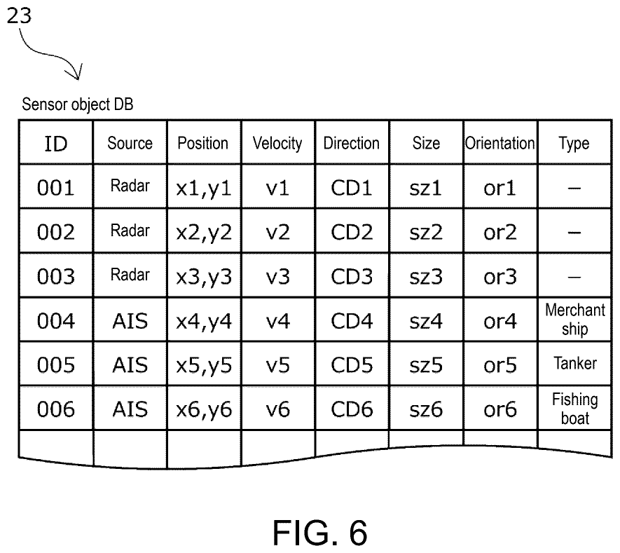

The sensor object DB 23 includes fields such as “ID”, “Source”, “Position”, “Velocity”, “Direction”, “Size”, “Orientation”, and “Type”, as illustrated in FIG. 6.

“ID” is an identifier of the object detected by the radar 3 or AIS 4. “Source” indicates which object sensor the object data was acquired from.

“Position” represents the position of the object. The position of the object is expressed in absolute coordinates of latitude and longitude. In the case of the radar 3, the position of the object included in the TT data is a relative position with reference to the own ship SH, so it is converted to absolute coordinates using the position of the own ship SH detected by the GNSS receiver 6. In the case of AIS 4, the position of the object corresponds to the position included in the AIS data.

“Velocity” represents the velocity of the object. In the case of the radar 3, the velocity of the object is calculated based on the temporal change of the position of the object. In the case of AIS 4, the velocity of the object corresponds to the ship speed and heading included in the AIS data. Velocity is a vector quantity including ship speed and course or heading.

“Direction” represents the direction of the object with reference to the own ship SH. In the case of the radar 3, the direction of the object is specified with reference to the bow direction BW of the own ship SH detected by the orientation sensor 7. In the case of AIS 4, the direction of the object is calculated based on the position of the object and the bow direction BW of the own ship SH detected by the orientation sensor 7.

“Size” represents the size of the object. In the case of the radar 3, the size of the object corresponds to the size of an echo image. In the case of AIS 4, the size of the object corresponds to the ship length included in the AIS data.

“Orientation” represents the orientation of the object. In the case of the radar 3, the orientation of the object is expressed by the course of the object included in the TT data. In the case of AIS 4, the orientation of the object is expressed by the heading included in the AIS data.

“Type” represents the type of the object. In the case of the radar 3, the type of the object is basically not distinguishable, but the type of the object may be estimated from the echo image using a trained model. In the case of AIS 4, the type of the object corresponds to the type included in the AIS data.

Returning to the description of FIG. 2, the object identification unit 14 identifies the objects registered in the camera object DB 22 and the objects registered in the sensor object DB 23. Specifically, the object identification unit 14 determines whether the objects are identical or not by comparing the direction of the objects registered in the camera object DB 22 with the direction of the objects registered in the sensor object DB 23.

The capturing direction calculation unit 15 calculates a difference θ between the capturing direction MD of the camera 5 and the bow direction BW, as well as calculates the capturing direction MD of the camera 5 with reference to the bow direction BW, based on the direction of the objects registered in the camera object DB 22 and the direction of the objects registered in the sensor object DB 23.

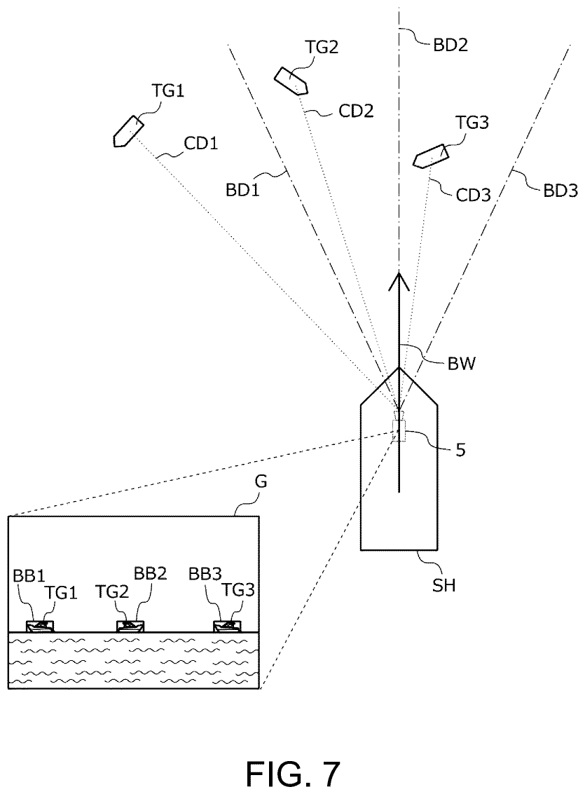

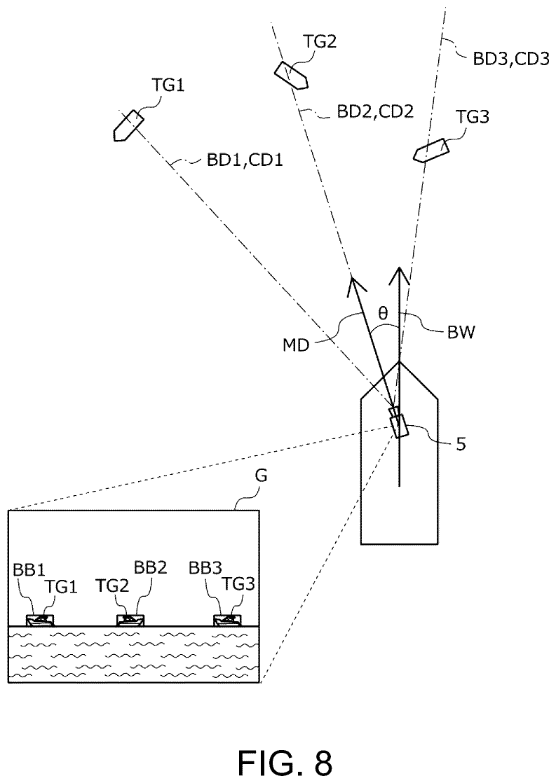

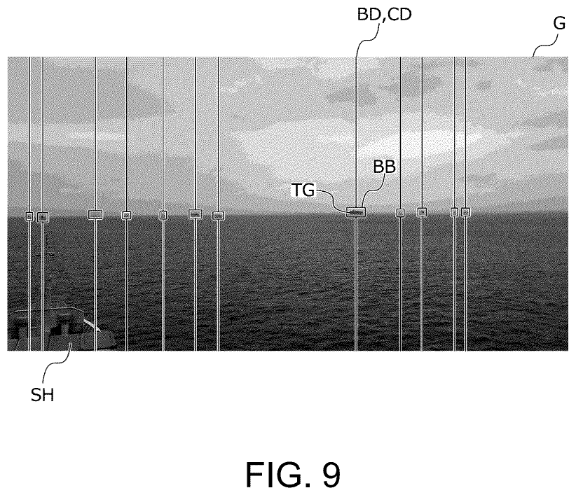

FIG. 7 and FIG. 8 are diagrams for describing the identification of objects TG1 to TG3 by the object identification unit 14 and the calibration of the capturing direction MD of the camera 5 by the capturing direction calculation unit 15. In FIG. 9, for reference, vertical lines representing directions BD, CD of the objects TG1 to TG3 in an image G are illustrated.

Around the own ship SH, the objects TG1 to TG3 exist, and the image G captured by the camera 5 mounted on the own ship SH includes the objects TG1 to TG3. Furthermore, the image G illustrates bounding boxes BB1 to BB3 surrounding the objects TG1 to TG3 recognized by the region recognition model.

Directions BD1 to BD3 of the objects based on the camera 5 are calculated based on the horizontal in-image position of the bounding boxes BB1 to BB3 in the image G. Specifically, the directions BD1 to BD3 are calculated based on the capturing direction of the camera 5, the horizontal angle of view of the camera 5, and the horizontal in-image position of the bounding boxes BB1 to BB3 in the image G.

On the other hand, directions CD1 to CD3 of the objects based on the radar 3 or AIS 4 are calculated with reference to the bow direction BW of the own ship SH detected by the orientation sensor 7. The directions CD1 to CD3 correctly represent the directions of the objects TG1 to TG3.

FIG. 7 illustrates an example where the directions BD1 to BD3 of the objects were calculated based on the assumption that the camera 5 is facing the bow direction BW, but in reality, the camera 5 is facing a direction different from the bow direction BW.

In this case, the objects TG1 to TG3 do not exist on the directions BD1 to BD3 of the objects based on the camera 5. In other words, the directions BD1 to BD3 of the objects based on the camera 5 are shifted from the directions CD1 to CD3 of the objects based on the radar 3 or AIS 4.

The object identification unit 14 identifies the objects TG1 to TG3 by comparing the directions BD1 to BD3 of the objects based on the camera 5 with the directions CD1 to CD3 of the objects based on the radar 3 or AIS 4.

Specifically, the object identification unit 14 searches for a rotation angle where the appearance pattern of the directions BD1 to BD3 of the objects based on the camera 5 matches the appearance pattern of the directions CD1 to CD3 of the objects based on the radar 3 or AIS 4.

In addition, the object identification unit 14 may identify the objects TG1 to TG3 by further comparing one or more of the size, orientation, and type of the objects, in addition to the direction of the objects. This makes it possible to improve the identification accuracy of the objects.

FIG. 8 illustrates an example where the directions BD1 to BD3 of the objects based on the camera 5 are rotated until they match the directions CD1 to CD3 of the objects based on the radar 3 or AIS 4.

The capturing direction calculation unit 15 determines the direction in which the camera 5 is facing when the directions BD1 to BD3 of the objects based on the camera 5 are rotated until they match the directions CD1 to CD3 of the objects based on the radar 3 or AIS 4 as the actual capturing direction MD of the camera 5. In other words, the capturing direction calculation unit 15 calculates backwards the actual capturing direction MD of the camera 5 from the directions BD1 to BD3 rotated to match the directions CD1 to CD3.

The actual capturing direction MD of the camera 5 is expressed by the difference θ between the capturing direction MD of the camera 5 and the bow direction BW, and is calculated as the capturing direction MD of the camera 5 with reference to the bow direction BW.

The difference θ between the capturing direction MD of the camera 5 and the bow direction BW is calculated based on the rotation angle of the directions BD1 to BD3 that match the directions CD1 to CD3. In this example, since the directions BD1 to BD3 were calculated on the assumption that the camera 5 was initially facing the bow direction BW, the rotation angle of the directions BD1 to BD3 that match the directions CD1 to CD3 is equal to the difference θ between the capturing direction MD of the camera 5 and the bow direction BW.

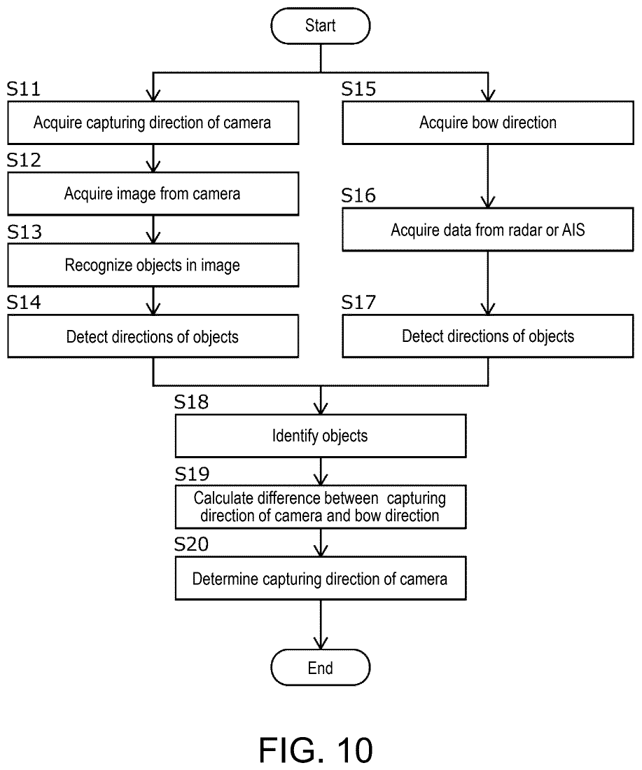

FIG. 10 is a flowchart illustrating an example of a procedure related to the processing of calibrating the capturing direction MD of the camera 5 among the navigation support methods realized in the navigation support system 100. The processing circuitry 1 executes the information processing illustrated in this figure according to a program.

First, the processing circuitry 1 acquires the capturing direction of the camera 5 (S11). Here, the capturing direction of the camera 5 before calibration is acquired. Next, the processing circuitry 1 acquires an image G captured by the camera 5 (S12).

Next, the processing circuitry 1 recognizes the objects TG1 to TG3 in the image G by bounding boxes BB1 to BB3 by inputting the acquired image G into the region recognition model (S13, processing as the image recognition unit 11).

Next, the processing circuitry 1 detects directions B1 to B3 of the objects with reference to the own ship SH based on the recognition result of the image G (S14, processing as the data acquisition unit 12).

On the other hand, the processing circuitry 1 detects the bow direction BW of the own ship SH using the orientation sensor 7 (S15). Next, the processing circuitry 1 acquires object data from the radar 3 or AIS 4 (S16, processing as the data acquisition unit 13).

Next, the processing circuitry 1 detects the directions C1 to C3 of the objects with reference to the own ship SH based on the object data acquired from the radar 3 or AIS 4 (S17, processing as the data acquisition unit 13)

Then, the processing circuitry 1 identifies the objects TG1 to TG3 recognized from the image G with the objects TG1 to TG3 detected by the radar 3 or AIS 4 (S18, processing as the object identification unit 14).

Next, the processing circuitry 1 calculates the difference θ between the actual capturing direction MD of the camera 5 and the bow direction BW, and based on this, determines the capturing direction MD of the camera 5 (S19, S20, processing as the capturing direction calculation unit 15).

With this, the series of processing for calibrating the capturing direction MD of the camera 5 is completed.

The disclosure has been described with respect to the embodiments above. However, the disclosure is not limited to the embodiments described above, and various modifications are of course possible for those skilled in the art.

The following lists representative embodiments of the disclosure.

(1)

A navigation support system, including:
a camera installed on a ship and configured to acquire an image including an object at sea;
an orientation sensor configured to detect a bow direction of the ship;
an object sensor configured to detect a position of the object; and
processing circuitry configured to:
   recognize a region of the object in the image; and
   calculate a difference between a capturing direction of the camera and the bow direction based on a horizontal in-image position of the object in the image and a direction of the object with reference to the ship.
      (2)

The navigation support system according to (1), wherein the camera includes a drive unit configured to change the capturing direction horizontally.

(3)

The navigation support system according to (1) or (2), wherein the processing circuitry calculates the capturing direction of the camera with reference to the bow direction.

(4)

The navigation support system according to any one of (1) to (3), wherein the processing circuitry is further configured to identify the object recognized in the image with the object detected by the object sensor.

(5)

The navigation support system according to (4), wherein the processing circuitry identifies a plurality of the objects based on a horizontal appearance pattern of a plurality of the objects in the image and a circumferential appearance pattern of a plurality of the objects with reference to the ship.

(6)

The navigation support system according to any one of (1) to (5), wherein
the processing circuitry recognizes a size of the object,
the object sensor further detects the size of the object, and
the processing circuitry identifies the object based on the size of the object.
   (7)

The navigation support system according to any one of (1) to (6), wherein
the processing circuitry recognizes an orientation of the object,
the object sensor further detects the orientation of the object, and
the processing circuitry identifies the object based on the orientation of the object.
   (8)

The navigation support system according to any one of (1) to (7), wherein
the processing circuitry recognizes a type of the object,
the object sensor further detects the type of the object, and
the processing circuitry identifies the object based on the type of the object.
   (9)

The navigation support system according to any one of (1) to (8), wherein the object sensor is a radar.

(10)

The navigation support system according to any one of (1) to (9), wherein the object sensor is an AIS (Automatic Identification System).

(11)

A navigation support method, including:
acquiring an image including an object on the sea by a camera installed on a ship;
recognizing a region of the object in the image;
detecting a bow direction of the ship by an orientation sensor;
detecting a position of the object by an object sensor; and
calculating a difference between a capturing direction of the camera and the bow direction based on a horizontal in-image position of the object in the image and a direction of the object with reference to the ship.
   (12)

A computer-readable recording medium configured to record a program to cause a computer to:
acquire an image including an object on the sea generated by a camera installed on a ship;
recognize a region of the object in the image;
acquire a bow direction of the ship detected by an orientation sensor;
acquire a position of the object detected by an object sensor; and
calculate a difference between a capturing direction of the camera and the bow direction based on a horizontal in-image position of the object in the image and a direction of the object with reference to the ship.

### Terminology

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiment disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might,” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface.” The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated,” and other such relational terms should be construed, unless otherwise noted, to include removable, movable, fixed, adjustable, and/or releasable connections or attachments. The connections/attachments can include direct connections and/or connections having intermediate structure between the two components discussed.

Unless otherwise explicitly stated, numbers preceded by a term such as “approximately,” “about,” and “substantially” as used herein include the recited numbers, and also represent an amount close to the stated amount that still performs a desired function or achieves a desired result. For example, unless otherwise explicitly stated, the terms “approximately”, “about”, and “substantially” may refer to an amount that is within less than 10% of the stated amount. Features of embodiments disclosed herein preceded by a term such as “approximately”, “about”, and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A navigation support system, comprising:
a camera installed on a ship and configured to acquire an image including an object at sea;
an orientation sensor configured to detect a bow direction of the ship;
an object sensor configured to detect a position of the object; and
processing circuitry configured to:
recognize a region of the object in the image; and
calculate a difference between a capturing direction of the camera and the bow direction based on a horizontal in-image position of the object in the image and a direction of the object with reference to the ship.

2. The navigation support system according to claim 1, wherein
the camera comprises a drive unit configured to change the capturing direction horizontally.

3. The navigation support system according to claim 1, wherein
the processing circuitry calculates the capturing direction of the camera with reference to the bow direction.

4. The navigation support system according to claim 2, wherein
the processing circuitry calculates the capturing direction of the camera with reference to the bow direction.

5. The navigation support system according to claim 1, wherein
the processing circuitry is further configured to identify the object recognized in the image with the object detected by the object sensor.

6. The navigation support system according to claim 4, wherein
the processing circuitry is further configured to identify the object recognized in the image with the object detected by the object sensor.

7. The navigation support system according to claim 4, wherein
the processing circuitry identifies a plurality of the objects based on a horizontal appearance pattern of a plurality of the objects in the image and a circumferential appearance pattern of a plurality of the objects with reference to the ship.

8. The navigation support system according to claim 6, wherein
the processing circuitry identifies a plurality of the objects based on a horizontal appearance pattern of a plurality of the objects in the image and a circumferential appearance pattern of a plurality of the objects with reference to the ship.

9. The navigation support system according to claim 1, wherein
the processing circuitry further recognizes a size of the object,
the object sensor further detects the size of the object, and
the processing circuitry identifies the object based on the size of the object.

10. The navigation support system according to claim 5, wherein
the processing circuitry further recognizes a size of the object,
the object sensor further detects the size of the object, and
the processing circuitry identifies the object based on the size of the object.

11. The navigation support system according to claim 1, wherein
the processing circuitry recognizes an orientation of the object,
the object sensor further detects the orientation of the object, and
the processing circuitry identifies the object based on the orientation of the object.

12. The navigation support system according to claim 5, wherein
the processing circuitry recognizes an orientation of the object,
the object sensor further detects the orientation of the object, and
the processing circuitry identifies the object based on the orientation of the object.

13. The navigation support system according to claim 9, wherein
the processing circuitry recognizes an orientation of the object,
the object sensor further detects the orientation of the object, and
the processing circuitry identifies the object based on the orientation of the object.

14. The navigation support system according to claim 1, wherein
the processing circuitry recognizes a type of the object,
the object sensor further detects the type of the object, and
the processing circuitry identifies the object based on the type of the object.

15. The navigation support system according to claim 5, wherein
the processing circuitry recognizes a type of the object,
the object sensor further detects the type of the object, and
the processing circuitry identifies the object based on the type of the object.

16. The navigation support system according to claim 9, wherein
the processing circuitry recognizes a type of the object,
the object sensor further detects the type of the object, and
the processing circuitry identifies the object based on the type of the object.

17. The navigation support system according to claim 13, wherein
the processing circuitry recognizes a type of the object,
the object sensor further detects the type of the object, and
the processing circuitry identifies the object based on the type of the object.

18. The navigation support system according to claim 1, wherein
the object sensor is a radar or AIS (Automatic Identification System).

19. A navigation support method, comprising:
acquiring an image including an object on the sea by a camera installed on a ship;
recognizing a region of the object in the image;
detecting a bow direction of the ship by an orientation sensor;
detecting a position of the object by an object sensor; and
calculating a difference between a capturing direction of the camera and the bow direction based on a horizontal in-image position of the object in the image and a direction of the object with reference to the ship.

20. A computer-readable recording medium configured to record a program to cause a computer to:
acquire an image including an object on the sea generated by a camera installed on a ship;
recognize a region of the object in the image;
acquire a bow direction of the ship detected by an orientation sensor;
acquire a position of the object detected by an object sensor; and
calculate a difference between a capturing direction of the camera and the bow direction based on a horizontal in-image position of the object in the image and a direction of the object with reference to the ship.
